(19) United States
(12) Patent Application Publication
(10) Pub. No.: US 2026/0233779 A1
(43) Pub. Date: Aug. 13, 2026

(54) VEHICLE BODY FRAME STRUCTURE

(71) Applicant: TOYOTA JIDOSHA KABUSHIKI KAISHA, Toyota-shi (JP)

(72) Inventors: Kento SHIGEISHI, Toyota-shi (JP); Yuto Imaeda, Okazaki-shi (JP); Kazuya Ogawa, Nisshin-shi (JP); Ryosuke Chikazawa, Toyota-shi (JP)

(73) Assignee: TOYOTA JIDOSHA KABUSHIKI KAISHA, Toyota-shi (JP)

(21) Appl. No.: 19/421,085

(22) Filed: Dec. 16, 2025

(30) Foreign Application Priority Data
Feb. 7, 2025 (JP) 2025-019271

(51) Int. Cl. B62D 21/15

(52) U.S. Cl. CPC B62D 21/15

(57) ABSTRACT

A vehicle body frame structure, incudes: a left and right pair of side frames; a first cross member and a second cross member extending in a vehicle width direction and spanning between the side frames, at a vehicle front side of the side frames, being in this order from the vehicle front side; a center frame extending toward a vehicle rear side from a substantially central part, in the vehicle width direction, of the second cross member; and a stopper member provided at a substantially central part, in the vehicle width direction, of either one of the first cross member or the second cross member so as to be positioned between the first cross member and the second cross member in plan view, with a gap provided between the stopper member and another one of the first cross member or the second cross member.

### CROSS-REFERENCE TO RELATED APPLICATION

This application is based on and claims priority under 35 USC 119 from Japanese Patent Application No. 2025-019271 filed on February 7, 2025, the disclosure of which is incorporated by reference herein in its entirety.

### Technical Field

The present disclosure relates to a vehicle body frame structure.

### Related Art

A vehicle body structure of an electric vehicle in which plural cross members extending in the vehicle width direction are installed between a left and right pair of side frames extending in the front-rear direction, and a battery pack is disposed above the plural cross members, is conventionally known (see, for example, Japanese Patent Application Laid-open (JP-A) No. 2018-144700. The vehicle body structure includes a reinforcing frame extending along a rear end face of the battery pack in the vehicle width direction, and deformation of the vehicle body due to an impact during a rear-on collision of the electric vehicle is suppressed.

However, there is still room for improvement in structures that both protect the battery pack during an offset collision of the vehicle and protect the occupant during a frontal collision.

### SUMMARY

The present disclosure provides a vehicle body frame structure that is capable of achieving both protection of a battery pack during a vehicle offset collision and protection of an occupant during a frontal collision.

A vehicle body frame structure of a first aspect according to the present disclosure includes: a left and right pair of side frames, each extending in a vehicle front-rear direction; a first cross member and a second cross member extending in a vehicle width direction and spanning between the side frames at a vehicle front side of the side frames, the first cross member and the second cross member being in order from the vehicle front side; a center frame extending toward a vehicle rear side from a substantially central part, in the vehicle width direction, of the second cross member; and a stopper member provided at a substantially central part, in the vehicle width direction, of either one of the first cross member or the second cross member so as to be positioned between the first cross member and the second cross member in plan view, with a gap provided between the stopper member and another one of the first cross member or the second cross member.

According to the first aspect, first and second cross members extending in the vehicle width direction are provided, in order from the vehicle front side, at a vehicle front side of, and spanning between, a left and right pair of side frames extending in the vehicle front-rear direction. Further, a center frame extends from substantially central part, in the vehicle width direction, of the second cross member toward a vehicle rear side. Further, a stopper member is provided at a substantially central part, in the vehicle width direction, of either one of the first cross member or the second cross member so as to be positioned between the first cross member and the second cross member in plan view, and a gap is provided between the stopper member and the other one of the first cross member or the second cross member.

Here, during an offset collision of the vehicle, the first cross member contacts the stopper member, and an input load is transmitted from the first cross member to the vehicle rear side via a load transmission path through the stopper member and the center frame. Thus, for example, even in cases in which a battery pack is provided between the left and right pair of side frames, contact of the side frame at the offset collision side with the battery pack is suppressed or prevented.

Further, during a frontal collision with a relatively lower load than in an offset collision, the input load is absorbed by the side frames, and the other one of the first cross member or the second cross member does not contact the stopper member. Thus, excessive load transmission is suppressed, and the occupant is appropriately protected. Thus, according to the first aspect, both protection of the battery pack during an offset collision of the vehicle and protection of the occupant during a frontal collision can be realized.

Further, a vehicle body frame structure of a second aspect according to the present disclosure is the vehicle body frame structure of the first aspect, in which a reinforcing bulk is provided inside the stopper member.

According to the second aspect, a reinforcing bulk is provided inside the stopper member. This improves the rigidity of the stopper member, enabling stable load transmission to be realized.

Further, a vehicle body frame structure of a third aspect according to the present disclosure is the vehicle body frame structure of the first or the second aspect, in which a reinforcing member is provided at a substantially central part, in the vehicle width direction, at an upper face of the other one of the first cross member or the second cross member, and a combined height of the reinforcing member and the other one of the first cross member or the second cross member is the same as the height of the stopper member.

According to the third aspect, a reinforcing member is provided at a substantially central part, in the vehicle width direction, of the upper face of the other one of the first cross member or the second cross member, and a height obtained by combining the other one of the first cross member or the second cross member with the reinforcing member is the same as the height of the stopper member. Accordingly, the contact area with the stopper member at the other one of the first cross member or the second cross member is increased to the extent of the reinforcing member, and the other one of the first cross member or the second cross member including the reinforcing member can stably contact the stopper member. Note that in the present disclosure, "the same" includes substantially the same, including discrepancies of about several millimeters from exactly the same.

As described above, the present disclosure enables both protection of the battery pack during a vehicle offset collision and protection of the occupant during a frontal collision to be achieved.

### BRIEF DESCRIPTION OF THE DRAWINGS

An exemplary embodiment of the present disclosure will be described in detail based on the following figures, wherein:

FIG. 1 is a schematic plan view illustrating a state at a time of frontal collision of a vehicle provided with vehicle body frame structure according to the present embodiment;

FIG. 2 is a schematic perspective view illustrating the vehicle body frame structure according to the present embodiment;

FIG. 3 is a schematic perspective view illustrating a stopper member configuring a vehicle body frame structure according to the present embodiment;

FIG. 4 is a schematic plan view illustrating a state at a time of offset collision of a vehicle including the vehicle body frame structure according to the present embodiment;

FIG. 5 is a schematic side view illustrating a state at a time of offset collision of a vehicle including the vehicle body frame structure according to the present embodiment; and

FIG. 6 is a graph illustrating a relationship between stroke and load at a time of frontal collision and at a time of offset collision of a vehicle provided with vehicle body frame structure according to the present embodiment.

### DETAILED DESCRIPTION

Detailed explanation follows regarding exemplary embodiments of the present disclosure, based on the drawings. Note that for convenience of explanation, in each of the drawings as appropriate, the arrow UP is set in the vehicle upper direction, the arrow FR is set in the vehicle front direction, and the arrow RH is set in the vehicle rightward direction. Further, in the following explanation, unless specifically stated otherwise, when up and down, front and rear, and left and right directions are described, these indicate up and down, front and rear, and left and right in a vehicle. Further, the left and right direction is the same as the vehicle width direction.

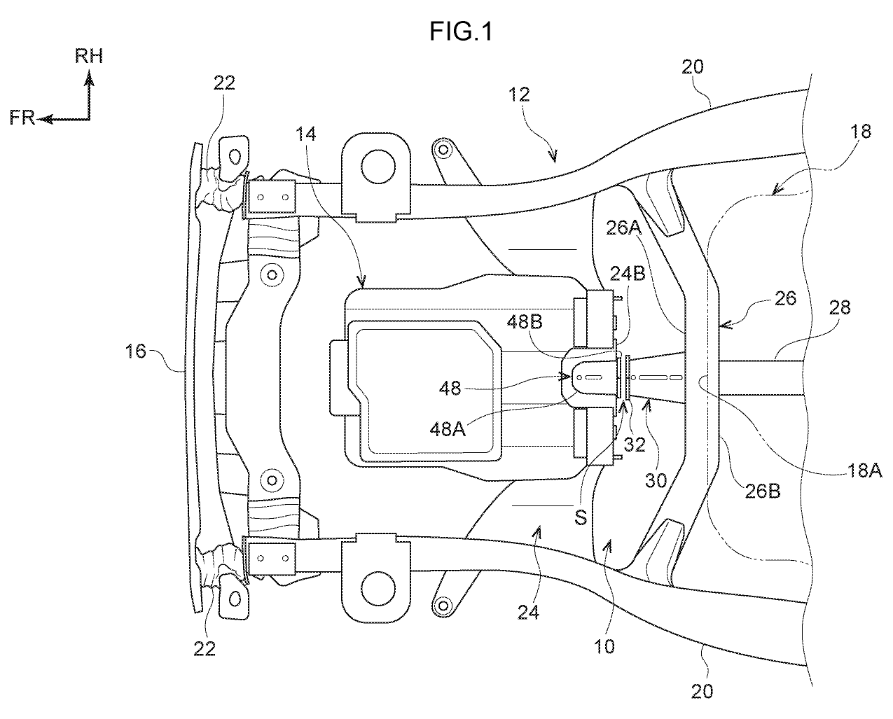

As illustrated in FIG. 1, a vehicle 12, such as an electric automobile, including a vehicle body frame structure 10 according to the present exemplary embodiment, includes a left and right pair of side frames 20 extending in the front-rear direction. The side frame 20 is formed in a substantially rectangular closed cross-section shape when viewed from the extending direction thereof. Further, at a front side of the side frames 20, a first cross member 24 and a second cross member 26 extending in the vehicle width direction are installed in order from the front side, spanning between the side frames 20. The first cross member 24 and the second cross member 26 are also formed in a substantially rectangular closed cross-section shape.

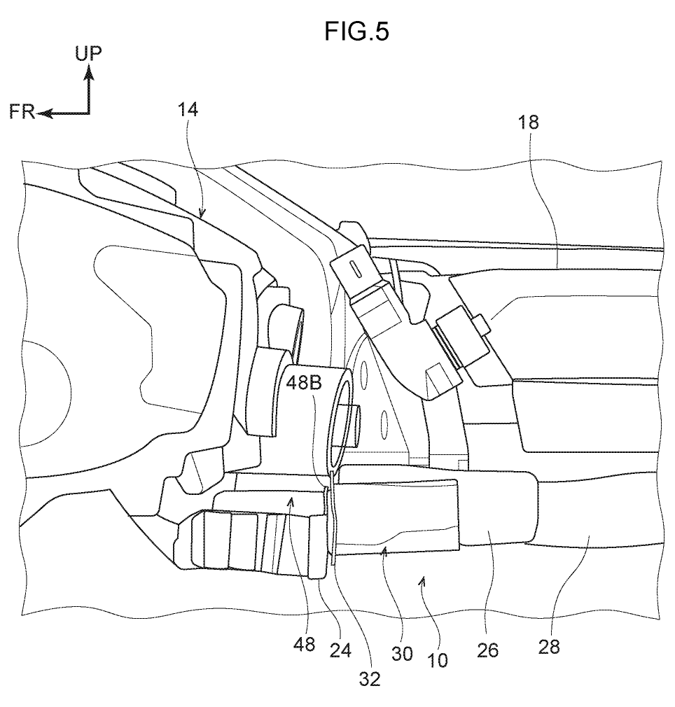

A power unit 14 including a motor or the like is provided at a substantially central portion in the vehicle width direction above and at the front side of the first cross member 24 (see also FIG. 5). Further, a crash box 22 is provided at a front end portion of each side frame 20, which projects further toward the front side than the power unit 14 in plan view, and a front bumper reinforcement 16 extending in the vehicle width direction is installed at a front end portion of each crash box 22.

Further, a center frame 28 extends rearward from a substantially vehicle width direction center portion of a rear wall 26B of the second cross member 26. Namely, a third cross member (not illustrated) extending in the vehicle width direction is installed at the rear side of the side frames 20, and the center frame 28 is installed between the third cross member and the second cross member 26. The center frame 28 is also formed in a substantially rectangular closed cross-section shape.

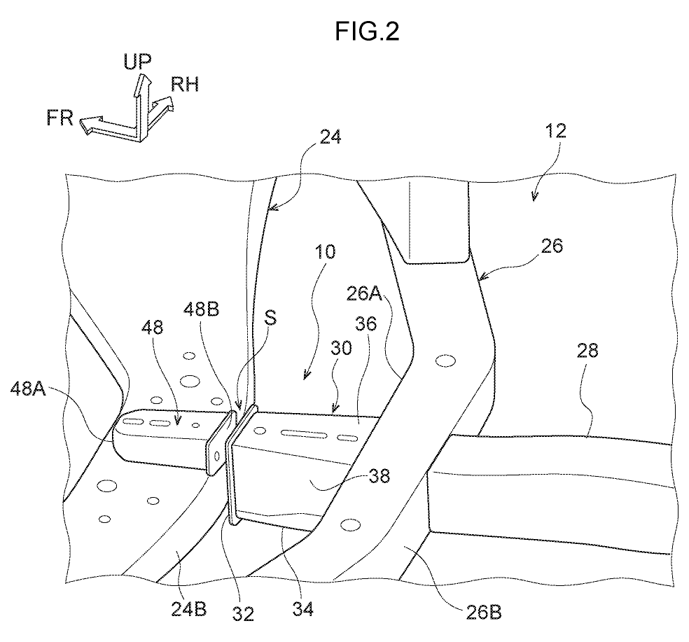

Further, a height (thickness along the up-down direction) of the center frame 28 is approximately the same as a height (thickness along the up-down direction) of the second cross member 26 (see FIG. 2). The battery pack 18 is disposed above the center frame 28 and between the left and right pair of side frames 20. Note that the battery pack 18 is installed such that the front end face 18A thereof does not pass the front wall 26A of the second cross member 26 in plan view (such that the battery pack 18 is positioned further toward the rear side than a stopper member 30, described later) (see FIG. 1).

Further, as illustrated in FIGS. 1 and 2, a stopper member 30 is provided at a substantially vehicle width direction center portion (at the same position as the center frame 28 in the vehicle width direction) of the front wall 26A of the second cross member 26. The stopper member 30 projects out from the front wall 26A of the second cross member 26 toward the rear wall 24B of the first cross member 24, and in plan view, it is positioned between the first cross member 24 and the second cross member 26.

The stopper member 30 is configured such that when a load is input from the front side, the stopper member 30 is supported from the rear side by the center frame 28 through the second cross member 26. Further, in normal times, the front wall 32 of the stopper member 30 is configured such that it is not in contact with the rear wall 24B of the first cross member 24. Namely, in a normal state, a predetermined gap S is formed between the front wall 32 of the stopper member 30 and the rear wall 24B of the first cross member 24.

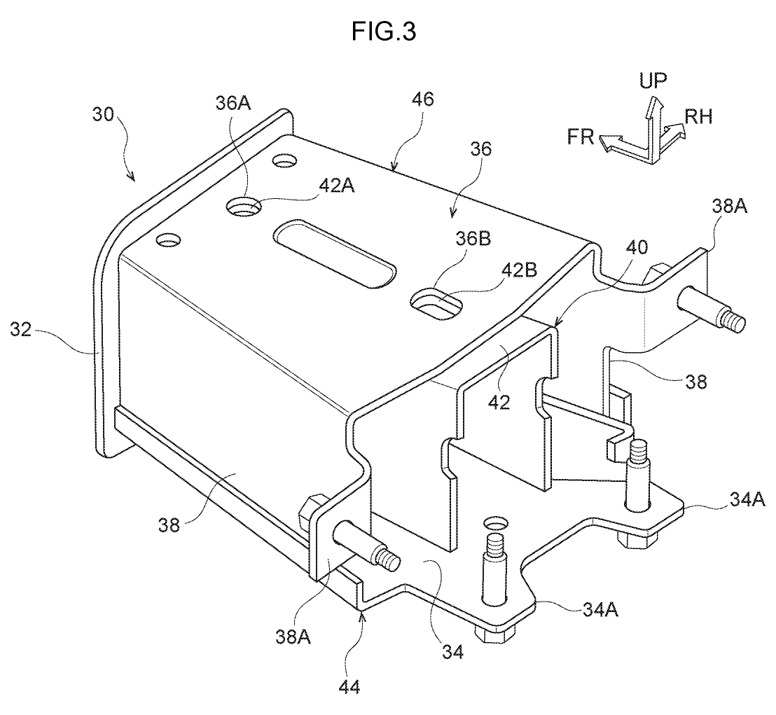

As illustrated in FIG. 3, the stopper member 30 is formed in a substantially rectangular closed cross-section shape when viewed from the front-rear direction, by the upper side member 46 and the lower side member 44 being joined together. The upper member 46 is formed in a substantially inverted U-shape when viewed from the front-rear direction, and configures the top wall 36 and the side walls 38 of the stopper member 30. The lower member 44 is formed in a substantially flat plate shape, and configures the bottom wall 34 of the stopper member 30.

Note that both left and right end portions of the lower member 44 are bent toward the upper side, and the configuration is such that they are joined to lower end portions (lower end portions of the side walls 38) at both left and right sides of the upper member 46 from the left and right direction outer sides. Thus, the stopper member 30 is configured to be formed in a substantially rectangular closed cross-section shape that is approximately the same height as the second cross member 26. A front wall 32 in a substantially rectangular plate shape is joined to a front end face of each of the upper member 46 and the lower member 44 so as to close the opening portion at the front end side.

Further, a reinforcing bulk 40 having a substantially inverted U-shape when viewed from the front-rear direction is provided at a substantially center portion in the left-right direction inside the stopper member 30 (between the upper member 46 and the lower member 44). A circular through-hole 36A is formed at a front portion at a substantially left-right direction center portion of the top wall 36 of the stopper member 30, and a long through-hole 36B, whose length direction is the front-rear direction, is formed at a rear portion. A circular through-hole 42A that is communicated with the through-hole 36A is formed at a front portion at a substantially left-right direction center portion of the top wall 42 of the reinforcing bulk 40, and a long through-hole 42B, whose length direction is the front-rear direction, that is communicated with the long through-hole 36B, is formed at a rear portion.

Namely, the configuration is such that in a state in which lower end portions at both left and right sides of the reinforcing bulk 40 contact the upper face of the bottom wall 34 of the stopper member 30, and the upper face of the top wall 42 contacts the inside face of the top wall 36 of the stopper member 30, bolts (not illustrated in the drawings) are inserted into the through holes 36A, 42A and the long through-holes 36B, 42B that are communicated with each other, and are screwed to a nut (not illustrated in the drawings) and the reinforcing bulk 40 is secured to the upper member 46 (top wall 36). Note that the reason that the rear portions are long through holes 36B, 42B is to absorb tolerance between the upper member 46 and the reinforcing bulk 40.

Further, a projecting portion 38A that juts out toward the left and right direction outer sides is integrally formed at a rear end portion of each side wall 38 of the stopper member 30, and each projecting portion 38A is attached to the front wall 26A of the second cross member 26 by bolt fastening. A left and right pair of extending portions 34A extending toward a rear side are integrally formed at a rear end portion of the bottom wall 34 of the stopper member 30, and each extending portion 34A is attached to a lower wall (not illustrated in the drawings) of the second cross member 26 by bolt fastening.

Further, as illustrated in FIGS. 1 and 2, a reinforcing member (projecting portion) 48 is provided on the upper face of the first cross member 24. The reinforcing member 48 is formed in a substantially rectangular box shape with a predetermined height (thickness), and a front wall 48A thereof is formed into a substantial arc shape in plan view. Further, an outer face (rear face) of the rear wall 48B of the reinforcing member 48 is a flat face, and is substantially flush with an outer face (rear face) of the rear wall 24B of the first cross member 24. A height obtained by combining the first cross member 24 and the reinforcing member 48 is substantially the same as a height of the stopper member 30.

Explanation follows regarding the mechanism of the vehicle body frame structure 10 according to the present exemplary embodiment configured as described above.

As described above, at the front side of the left and right pair of side frames 20 extending in the front-rear direction, a first cross member 24 and a second cross member 26 extending in the vehicle width direction are installed in order from the front side spanning between the side frames 20. A center frame 28 extends rearward from a substantially vehicle width direction center portion of the second cross member 26.

Further, a stopper member 30 is provided at a substantially vehicle width direction center portion of the front wall 26A of the second cross member 26, such that the stopper member 30 is positioned between the first cross member 24 and the second cross member 26 in plan view. The stopper member 30 has a predetermined clearance S between itself and the rear wall 24B of the first cross member 24. In other words, a predetermined gap S is formed between the front wall 32 of the stopper member 30 and the rear wall 24B of the first cross member 24.

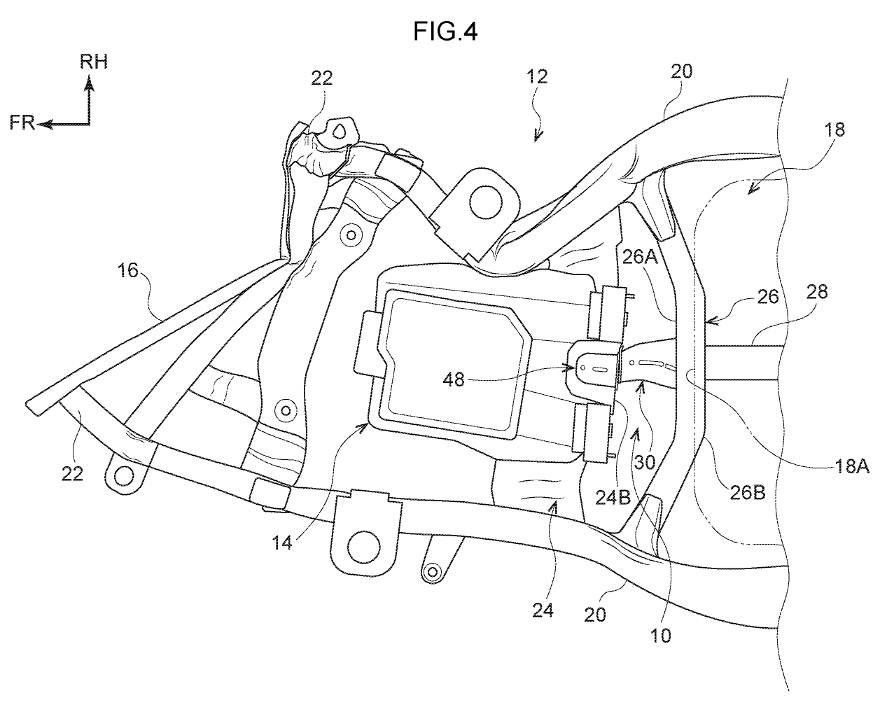

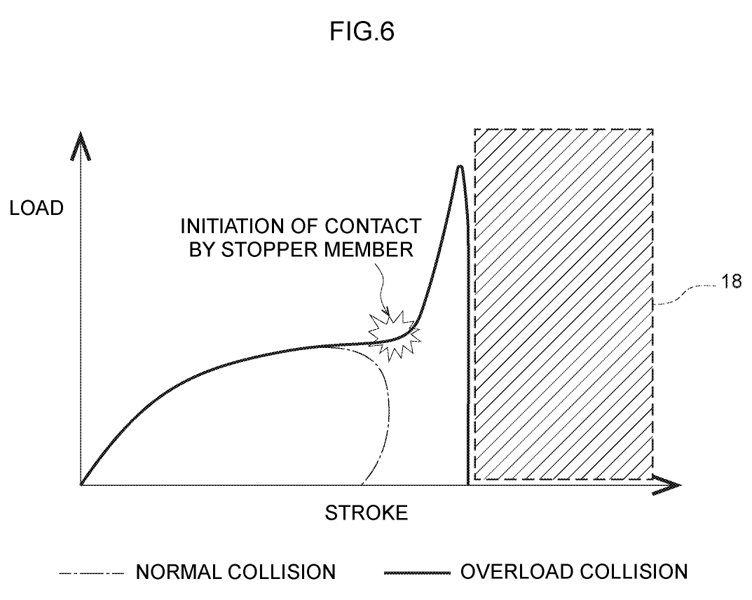

Here, as illustrated in FIGS. 4 and 5, at the time of an offset collision (an overload collision in FIG. 6) of the vehicle 12, the first cross member 24 contacts the stopper member 30, and the input load is efficiently transmitted from the first cross member 24 to the rear side via a load transmission path through the stopper member 30 and the center frame 28.

Thus, even if the battery pack 18 is provided between the left and right pair of side frames 20, as illustrated by the solid line in FIG. 6, it is possible to suppress or prevent the power unit 14 from contacting the battery pack 18, and it is also possible to suppress or prevent the side frame 20 at the offset collision side from contacting the battery pack 18.

At the time of a frontal collision (normal collision in FIG. 6), in which there is a relatively lower load than in an offset collision, as illustrated in FIG. 1, the input load is absorbed by the crash boxes 22 and the side frames 20, such that the first cross member 24 does not collide with the stopper member 30 (does not contact). Thus, in such cases, excessive load transmission as illustrated by the one-dot chain line in FIG. 6 can be suppressed, and the occupant can be appropriately protected.

Thus, according to the vehicle body frame structure 10 according to the present exemplary embodiment, protection of the battery pack 18 during an offset collision of the vehicle 12 and protection of the occupant during a frontal collision can both be achieved. Further, a reinforcing bulk 40 is provided inside the stopper member 30. This enables the rigidity of the stopper member 30 to be improved, and stable load transmission can be realized.

Further, a reinforcing member 48 is provided at a substantially vehicle width direction center portion of the upper face of the first cross member 24, and a height obtained by combining the first cross member 24 and the reinforcing member 48 is substantially the same as the height of the stopper member 30. Thus, the contact area between the rear wall 24B of the first cross member 24 and the front wall 32 of the stopper member 30 becomes larger to the extent of the size of the rear wall 48B of the reinforcing member 48, and the first cross member 24 including the reinforcing member 48, and the stopper member 30, can stably contact each other. Namely, stable load transmission can be realized.

Above, the vehicle body frame structure 10 according to the present exemplary embodiment has been explained based on the drawings; however, the vehicle body frame structure 10 according to the present exemplary embodiment is not limited to those illustrated in the drawings, and design modifications can be made as appropriate within a range that does not depart from the gist of the present disclosure. For example, the reinforcing bulk 40 need not be provided inside the stopper member 30, and the reinforcing member 48 need not be provided on the upper face of the first cross member 24.

Further, the stopper member 30 may be attached to the rear wall 24B of the first cross member 24, instead of the front wall 26A of the second cross member 26. In such cases as well, in normal times, a predetermined gap S is formed between the front wall 26A of the second cross member 26 and the front wall 32 of the stopper member 30.

Further, plural other cross members (not illustrated in the drawings) are installed between the left and right pair of side frames 20 in addition to the first cross member 24, the second cross member 26, and the third cross member described above. Namely, the configuration is such that the battery pack 18 is supported from below by the center frame 28 and these plural cross members.

What is claimed is:

1. A vehicle body frame structure, comprising:
a left and right pair of side frames, each extending in a vehicle front-rear direction;
a first cross member and a second cross member extending in a vehicle width direction and spanning between the side frames, at a vehicle front side of the side frames, the first cross member and the second cross member being in this order from the vehicle front side;
a center frame extending toward a vehicle rear side from a substantially central part, in the vehicle width direction, of the second cross member; and
a stopper member provided at a substantially central part, in the vehicle width direction, of either one of the first cross member or the second cross member so as to be positioned between the first cross member and the second cross member in plan view, with a gap provided between the stopper member and another one of the first cross member or the second cross member.

2. The vehicle body frame structure of claim 1, wherein a reinforcing bulk is provided inside the stopper member.

3. The vehicle body frame structure of claim 1, wherein:
a reinforcing member is provided at a substantially central part, in the vehicle width direction, at an upper face of the other one of the first cross member or the second cross member, and
a combined height of the reinforcing member and the other one of the first cross member or the second cross member is the same as the height of the stopper member.

4. The vehicle body frame structure of claim 2, wherein:
a reinforcing member is provided at a substantially central part, in the vehicle width direction, at an upper face of the other one of the first cross member or the second cross member, and
a combined height of the reinforcing member and the other one of the first cross member or the second cross member is the same as the height of the stopper member.
